(19) United States
(12) Patent Application Publication
(10) Pub. No.: US 2002/0138750 A1
(43) Pub. Date: Sep. 26, 2002

(54) Method of enabling one or more functional blocks of a controller

(76) Inventors: Irving A. Gibbs, Fletcher, NC (US); Mark A. Hampton, Pittsburgh, PA (US); Scott A. Baird, Munhall, PA (US)

Correspondence Address: Martin J. Moran, Cutler-Hammer Products, 170 Industry Drive, RIDC Park, West, Pittsburgh, PA, 15275, US

(21) Appl. No.: 09/815,954

(22) Filed: Mar. 23, 2001

(51) Int. Cl. G06F 12/14

(52) U.S. Cl. 713/193

(57) ABSTRACT

A method of enabling functional blocks for a controller includes encrypting a purchase code for a functional block of the controller based upon a unique controller identification number and an identifier number of the functional block. The purchase code is decrypted to obtain a decrypted controller identification number and a decrypted functional block identifier number. The functional block of the controller is enabled when the decrypted controller identification number is equal to the unique controller identification number and the decrypted functional block identifier number is equal to the functional block identifier number.

### BACKGROUND OF THE INVENTION

1. Field of the Invention

This invention pertains generally to a method of enabling at least one functional block of a controller and, more particularly, to such a method for functional blocks having an identifier and for a controller having a unique identification.

2. Background Information

Whenever control software or firmware includes a relatively significant level of functionality, it is important to employ a secure method, which restricts access to certain sensitive functions. In this manner, a particular user is protected from reconfiguring the control software, or from accessing functions that, when improperly used, might cause damage to a physical system (e.g., a utility generator).

Software vendors typically find it convenient to send standard software to all users and to restrict use of that standard software by a secure method.

Similarly, when a full set of firmware is shipped with hardware, it is desirable to employ a secure method, which restricts unauthorized use of firmware functions that have not been purchased. Hardware/firmware vendors typically find it convenient to ship the hardware with all of the firmware present and, then, to restrict the use of non-purchased functions by a secure method.

Known secure methods include customizing the firmware and/or software, or providing the user with a physical software or hardware key that enables specific functions.

For example, it is known to provide a code that the user employs to enable a certain set of software functions.

It is also known to employ programmable array logic (PAL), which is preconfigured (and locked to prevent user access), in order to enable one or more hardware functions, such as memory size.

It is further known to employ a plurality of security levels in a programming and monitoring tool for a controller, with each of the security levels (e.g., viewing, editing, saving a new configuration) having a unique password to restrict or authorize user access. It is also known to employ unique controller identification numbers and to assign passwords to each such controller as a function of the unique controller identification number.

The process of distinguishing a message in such a way as to hide its substance is encryption, which process turns plaintext (or cleartext) into ciphertext. Conversely, the process of decryption turns ciphertext back into plaintext (or cleartext). Encryption and decryption may also be referred to as to encipher and decipher, respectively. See, for example, ISO 7498-2: 1989, Information processing systems—Open Systems Interconnection—Basic Reference Model—Part 2: Security architecture.

A cryptographic algorithm or cipher is a general mathematical function employed for encryption and decryption, with one function being employed for encryption and a second related function being employed for decryption. Both of these functions employ one or more keys, with the security in these functions being based upon the keys rather than the specific functions. Hence, in some instances, the keys are kept secret or private in order to prevent unauthorized parties from reading the message.

A block cipher transforms a fixed-length block of plaintext into a block of ciphertext of the same length. The block cipher employs a user-provided secret key to provide both encryption and decryption. For example, in some instances, the size of the fixed-length block or block size is 64 bits.

An iterated block cipher encrypts a plaintext block by a process that has a plurality of rounds. In each round, the same transformation or round function is applied to the data using a subkey. Typically, the set of subkeys is derived from the user-provided secret key by a suitable key schedule. The number of rounds in an iterated block cipher depends upon the desired security level and the desired execution time or performance. Typically, increasing the number of rounds improves security, but at the expense of performance.

Feistel ciphers or DES-like ciphers are a special class of iterated block ciphers wherein ciphertext is calculated from plaintext by repeated application of the same transformation or round function. In a Feistel cipher, the text being encrypted is split into two halves. A round function, ƒ, is applied to one half using a subkey and the output of that round function, ƒ, is XORed with the other half. The two halves are then swapped. Each round follows the same pattern except for the last round where there is no swap. In the Feistel cipher, encryption and decryption are structurally identical, with the subkeys employed during encryption at each round being taken in reverse order during decryption.

It is possible to design iterative ciphers that are not Feistel ciphers, yet whose encryption and decryption, after a certain reordering or recalculation of variables, are structurally the same. One such example is IDEA.

The Data Encryption Standard (DES) is a symmetric encryption/decryption block cipher defined and endorsed by the United States government, in 1977, as an official standard. See Federal Information Processing Standards publication FIPS PUB 46. DES is well known, widely used and is still considered reasonably secure. The same secret key is employed, for example, by both a sender and a receiver to encrypt and decrypt a message, or to store a file on a hard disk in encrypted form. DES has a 64-bit block size, uses a 56-bit secret key during encryption, by means of permutation and substitution, and employs 16 rounds.

A Secure And Fast Encryption Routine (SAFER) is a non-proprietary block cipher, which employs slightly different encryption and decryption procedures, a 64-bit block size and, in one version, a 64-bit key size. SAFER employs a variable number of rounds, with a maximum of about ten rounds and a minimum of at least about six rounds. Only byte-based operations are employed in order to provide utility in smart card-based applications, which have limited processing power.

An Advanced Encryption Standard (AES) is a proposed unclassified, publicly disclosed, royalty-free encryption algorithm capable of protecting sensitive government information well into the next century. See Nechvatal, James, et al., Report on the Development of the Advanced Encryption Standard (AES), National Institute of Standards and Technology (Oct. 2, 2000). The National Institute of Standards and Technology has specified that the proposed algorithms must implement a symmetric block cipher, with a block size of 128 bits, and keys sizes of at least 128, 192 and 256 bits, with the algorithm having security at least as good as Triple-DES, but with significantly improved efficiency.

There is room for improvement in known methods of enabling one or more functional blocks for a controller.

### SUMMARY OF THE INVENTION

The present invention provides improvements in the method for enabling one or more functional blocks for a controller.

In accordance with the invention, a method of enabling at least one functional block for a controller comprises the steps of: encoding an enable code for the functional block of the controller based upon a unique identification of the controller and an identifier of the functional block; decoding the enable code for the functional block of the controller to obtain a decoded identification and a decoded identifier; and enabling the functional block of the controller when the decoded identification is equal to the unique identification and the decoded identifier is equal to the identifier of the functional block.

Preferably, the method includes selling and/or purchasing the enable code for the functional block of the controller based upon the unique identification of the controller and the identifier of the functional block.

The method may include entering the identifier of the functional block and the unique identification of the controller into an encoder; encoding a purchase code as the enable code from the identifier of the functional block and the unique identification of the controller; and selling the purchase code.

Preferably, the method includes employing an encryption algorithm having a secret key as the encoding step; and employing a corresponding decryption algorithm having the secret key as the decoding step.

The method may also include employing a block number as the identifier of the functional block; employing a unique controller number as the unique identification of the controller; inputting the block number and the unique controller number into the encryption algorithm; outputting a purchase code as the enable code from the encryption algorithm; inputting the purchase code into the decryption algorithm; outputting a decrypted block number and a decrypted controller number from the decryption algorithm; and enabling the functional block of the controller when the decrypted block number is equal to the identifier of the functional block and the decrypted controller number is equal to the unique identification.

### BRIEF DESCRIPTION OF THE DRAWINGS

A full understanding of the invention can be gained from the following description of the preferred embodiments when read in conjunction with the accompanying drawings in which:

FIG. 1 is a block diagram showing a method of enabling functional blocks for a controller in accordance with the present invention.

FIG. 2 is a block diagram of a controller, a programmer/monitor, an encoder and a decoder suitable for use with the method of FIG. 1.

FIG. 3 shows an example of two special functions, which are interpreted by the controller of FIG. 2.

FIGS. 4A-4B are flowcharts employed by the encoder, the programmer/monitor and the decoder of FIG. 2.

FIGS. 5A-5B are representations of displays employed by the programmer/monitor and the encoder of FIG. 2.

### DESCRIPTION OF THE PREFERRED EMBODIMENTS

As employed herein, the term “functional block” shall expressly include, but not be limited to, an algorithm, function, special function, routine, subroutine, module, sub-module, or program, which is executed or interpreted for execution by a processor.

As employed herein, the term “controller” shall expressly include, but not be limited to, processors which execute or interpret for execution one or more functional blocks, such as, for example, excitation controllers, programmable logic controllers, mainframe computers, mini-computers, workstations, personal computers, microcomputers, and other microprocessor-based processors or computers.

As employed herein, the term “encoding” means encrypting, enciphering, or converting a set of intelligible information into a corresponding cipher coded set of information.

As employed herein, the term “decoding” means decrypting, deciphering, or converting a cipher coded set of information into a corresponding set of intelligible information.

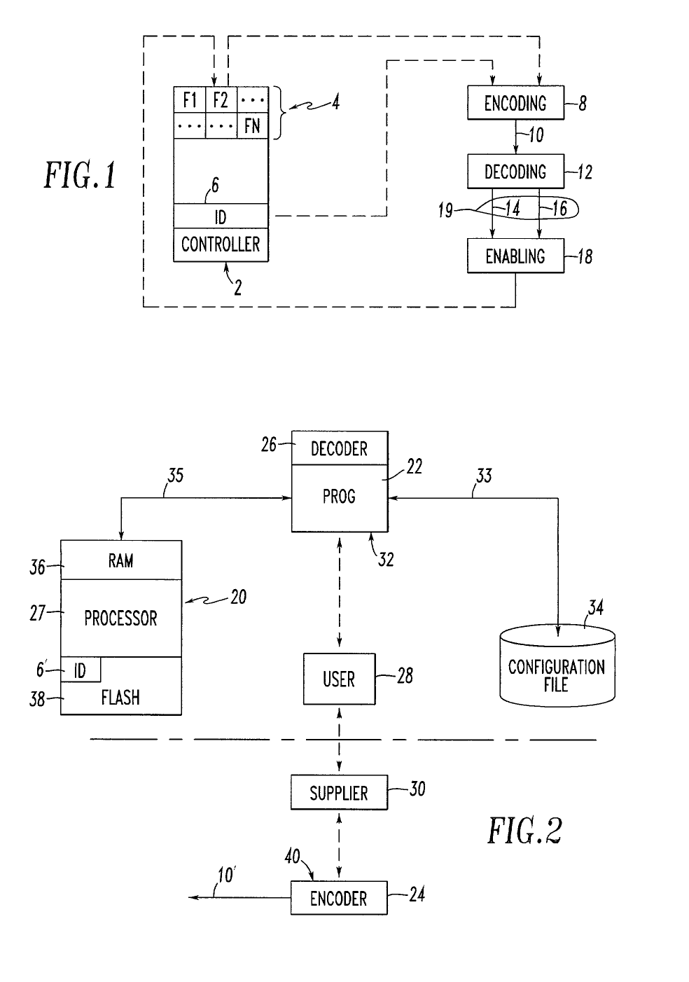

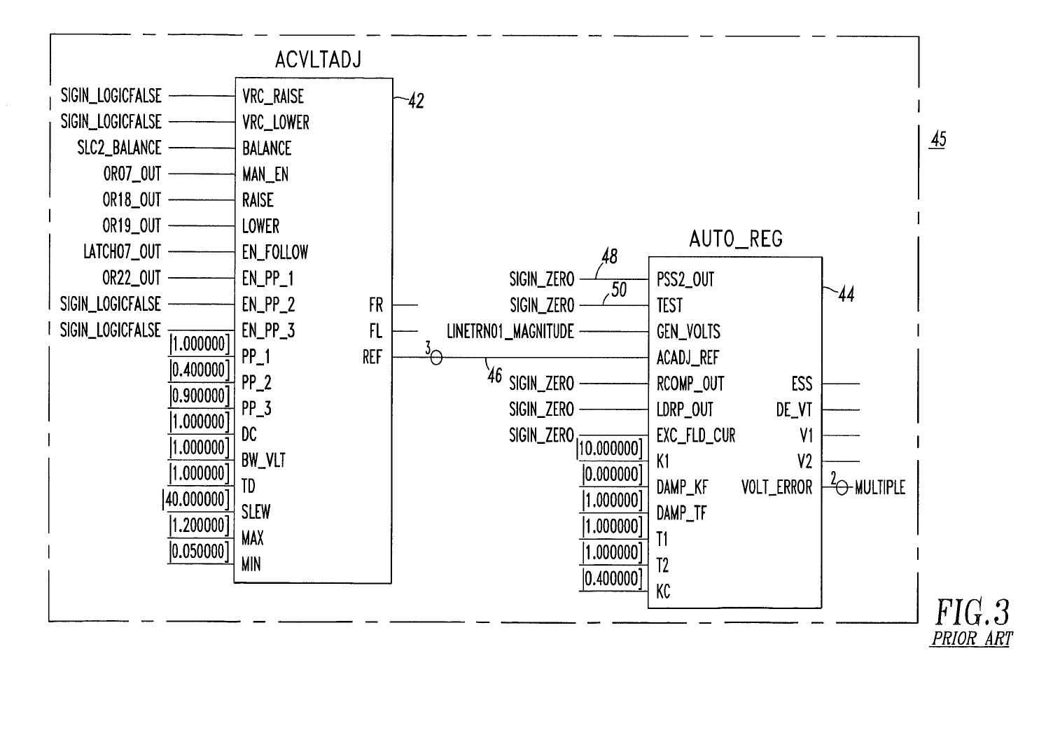

Referring to FIG. 1, a controller 2 includes a plurality of functional blocks 4. The controller 2 also includes a unique identification, such as the exemplary unique ID 6 (e.g., without limitation, a unique number, a unique name or symbol which corresponds to a unique number, a unique byte, a unique word, a unique 32-bit word). Other controllers (such as 20 of FIG. 2) have different identifications or IDs (such as 6′ of FIG. 2). Each of the functional blocks 4 includes an identifier, such as F1, F2 . . . FN, which in the exemplary embodiment is an identifier number (e.g., 1, 2, 3, . . . N, . . . ), although the invention is applicable to identifier names or symbols which correspond to identifier numbers.

A method of enabling one or more of the functional blocks 4 includes encoding, at 8, an enable code 10 for one of the functional blocks 4 (e.g., functional block F2 as shown in FIG. 1) based upon the unique identification 6 and the identifier number (e.g., 2) of that functional block; decoding, at 12, the enable code 10 for such functional block to obtain a decoded identification 14 and a decoded identifier 16; and enabling, at 18, such functional block (i.e., functional block F2 in this example) when the decoded identification 14 is equal to the unique ID 6 and the decoded identifier 16 is equal to the identifier number (i.e., 2 in this example) of such functional block. In other words, the functional block is enabled when the output 19 of the decoding step 12 is equal to the unique identification 6 and the identifier number (e.g., 2) of that functional block.

FIG. 2 shows a controller 20, a programmer/monitor (PROG) 22 for the controller 20, an encoder 24 and a decoder 26. The exemplary PROG 22 is a software configuration program which is employed to configure, monitor, maintain and debug the controller 20, which in the exemplary embodiment is a controller for an excitation control system (not shown). The controller 20 includes a suitable processor, such as a digital signal processor 27, that implements regulator, limiter, protection and system control functions, as well as a suitable microcontroller (not shown) that supervises communication with other system components (not shown) and an exemplary personal computer (PC) 32 for the PROG 22 and the decoder 26.

A user 28 employs the PROG 22 to program and monitor the controller 20 at the user's site, and to obtain the unique controller ID 6′ and the identifier number (e.g., 22) of a functional block (e.g., AD2) of interest, as shown in FIG. 1. In accordance with the present invention, the user 28 provides the unique controller ID 6′ and the identifier number of the functional block of interest to a remote supplier 30. Hence, in the exemplary embodiment, the encoder 24 is remotely located with respect to the PROG 22 and its associated decoder 26. The supplier 30, in turn, inputs the unique controller ID 6′ and the identifier number of the functional block of interest to the encoder 24, which outputs the corresponding enable code 10′ for the functional block of interest for the unique controller 20. The supplier 30, in turn, sends the enable code 10′ to the user 28 for input to the PROG 22 and its associated decoder 26, in order to enable the functional block of interest.

In accordance with a preferred practice of the invention, the supplier 30 sells, and the user 28 purchases, the enable code 10′. For example, the controller 20 may be supplied by the supplier 30 to the user 28 with a standard set of the functional blocks 4. The user 28, in turn, may desire to purchase the restricted (i.e., restricted to the particular controller 20) use of additional functional blocks 4, which is accomplished by the sale of the corresponding enable code 10′. The supplier 30 sends the functional block enable code(s) 10′ to the user 28 by any known communication method including, without limitation, by employing verbal communication, a telephone, a facsimile, electronic mail, conventional mail, courier, or a suitable memory device, such as a software installation disk, which is read by the PROG 22 that resides on the user's PC 32. Preferably, a suitably confidential communication channel is employed to send the enable code(s) 10′.

Typically, the user 28 employs the PROG 22 at installation to program the controller 20. Thereafter, the PROG 22 is used to monitor operations and, as needed, to tune input values. The exemplary PROG 22 also provides options for viewing, editing, and saving configuration information, and includes security levels to ensure that only authorized users can change configuration information.

The PROG 22 also defines configuration information for functional blocks 4 within the controller 20. The PROG 22 is initially employed to define, at 33, all configuration information in a configuration file 34 on the PC 32. Once the controller 20 is in a suitable state, the PROG 22 is used to download, at 35, the information to random access memory (RAM) 36 of the controller 20. Subsequently, the user 28 may employ the PROG 22 to tune configuration values within the RAM 36. Because information in RAM 36 is lost in the event of a power cycle, the user 28 saves the configuration information from RAM 36 to permanent flash memory 38 after the configuration has been satisfactorily tested. At power-up, the configuration information is obtained from the flash memory 38 and is employed to overwrite the indeterminate values of the RAM 36.

Similar to the decoder 26 on the exemplary user-PC 32, the encoder 24 may run on a supplier-PC 40 or any other suitable processor.

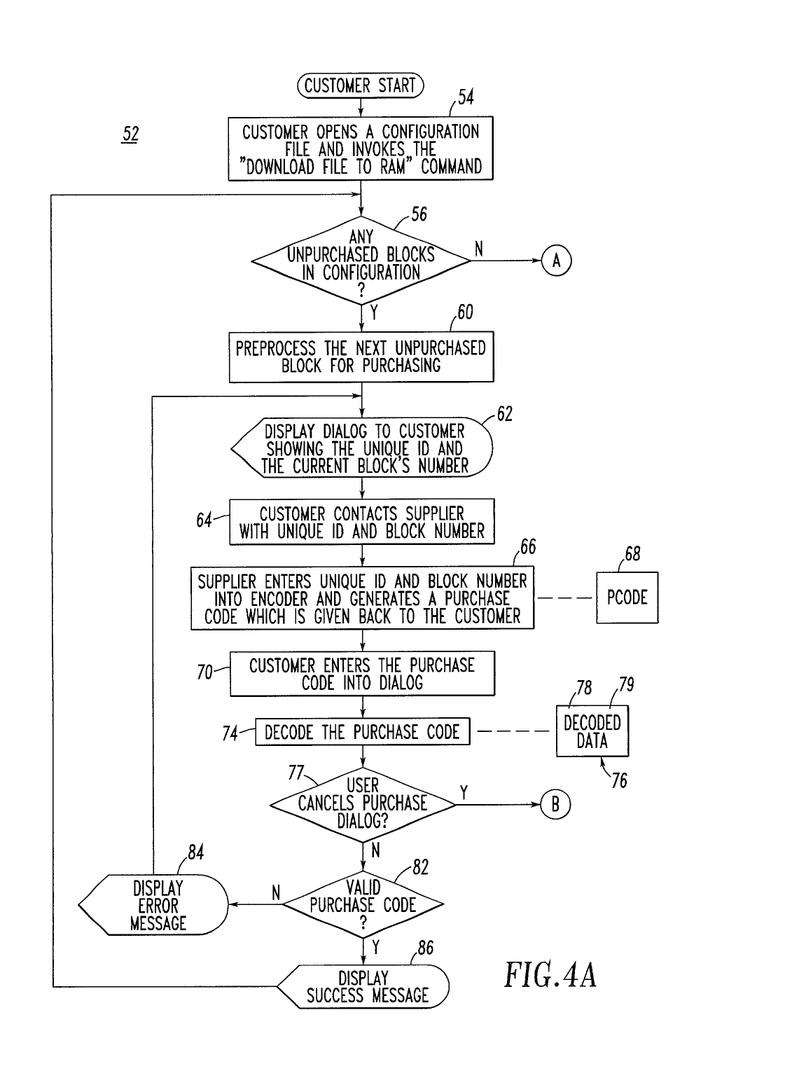

FIG. 3 shows an example of functional blocks or special functions, which are interpreted by the controller 20 of FIG. 2. The exemplary controller 20 contains blocks of code that control the functional blocks 4 of FIG. 1. A functional block can have any number (e.g., one or more) of inputs and outputs. An input can be a constant or a connection to another block. FIG. 3 shows exemplary ACVLTADJ and AUTO_REG blocks 42 and 44, respectively, of the controller 20 as displayed in a diagram window 45 of the PROG 22. Some of the inputs, such as the K1 through KC inputs of the AUTO_REG block 44, are constants. As shown by the connection line 46, the REF output of the ACVLTADJ block 42 is input by the ACADJ_REF input of the AUTO_REG block 44. In the exemplary embodiment, connection lines can be made invisible in the diagram window, in which case the output name is shown outside the input line. Exemplary connection lines 48 and 50 are shown with the AUTO_REG block inputs, such as PSS2_OUT and TEST, respectively.

By employing the PROG 22, the user defines the assignment of each block input as either a constant or a connection to another block, and the timing of the signals between blocks, which is called the execution strategy. There are two types of exemplary blocks: (1) interrupt blocks have an execution strategy (some interrupt blocks have a fixed execution strategy, meaning that the controller 20 assigns the strategy and the user 28 cannot change it); and (2) mainline blocks, which either execute or do not execute, and do not have an execution strategy. Some mainline blocks are fixed, meaning that the user 28 cannot turn off the execution. Some controllers 20 do not have mainline blocks. The execution strategy defines when a block executes in relation to all other blocks, the time slots in which the execution takes place, and the count of executions per cycle. Although exemplary functional blocks 4,42,44 are shown, the invention is applicable to a wide range of functional blocks for a controller (e.g., without limitation, a control algorithm for a process controller, a special function for a programmable logic controller).

Referring again to FIG. 2, the controller RAM 36 includes configuration information, which is executed by the controller 20. After the user downloads from the configuration file 34, the state of the controller 20 is resolved. The resolved state indicates that the configuration information is valid and ready to execute, but is not yet executing. In contrast, an unresolved state indicates a user error in the configuration information. To change the state, the user corrects the configuration error. The user 28 may set the controller state to execute in order to begin executing new values in RAM 36. The executing blocks state indicates that the functional blocks are executing in RAM 36. The controller 20 sets the executing application state. The user 28 may change parameter values while in this state, but cannot change that state.

All functional blocks in the configuration file 34 are configured before downloading. After the user defines a new configuration file 34, the user 28 downloads it to RAM 36, which sends the entire configuration to the controller 20 and overwrites the values in RAM 36. If one or more blocks are not completely configured, then the download to RAM command allows the user 28 to configure those blocks at that point. In order to download, the controller 20 is first placed in the resolved state. Otherwise, the download to RAM command asks if the user 28 wishes to change the state to resolved. The configuration the user 28 downloads is not automatically put into execution. After downloading, the user 28 changes the state from resolved to executing blocks as part of verifying the RAM configuration.

After the user 28 tunes the RAM configuration, the user saves it to flash memory 38. To create a backup copy of the tuned configuration, the user 28 uploads RAM 36 or flash memory 38 to the configuration file 34. To save the RAM configuration to flash memory 38, the user chooses save RAM to flash from a configuration menu (not shown). To upload to the configuration file 34, the user chooses upload RAM to file or upload flash to file from the configuration menu. After uploading, the user employs save, or save as, to save the file configuration to disk (not shown).

During initial connection with the controller 20, the PROG 22 determines the blocks that have been purchased (e.g., by accessing a “purchased blocks table” or a “blocks in use table” in disk or flash memory 38). The user 28 may enable and configure any purchased blocks provided that the user 28 has proper security clearance. Unpurchased blocks may be configured, but cannot be enabled until they are suitably flagged as being purchased by the user 28.

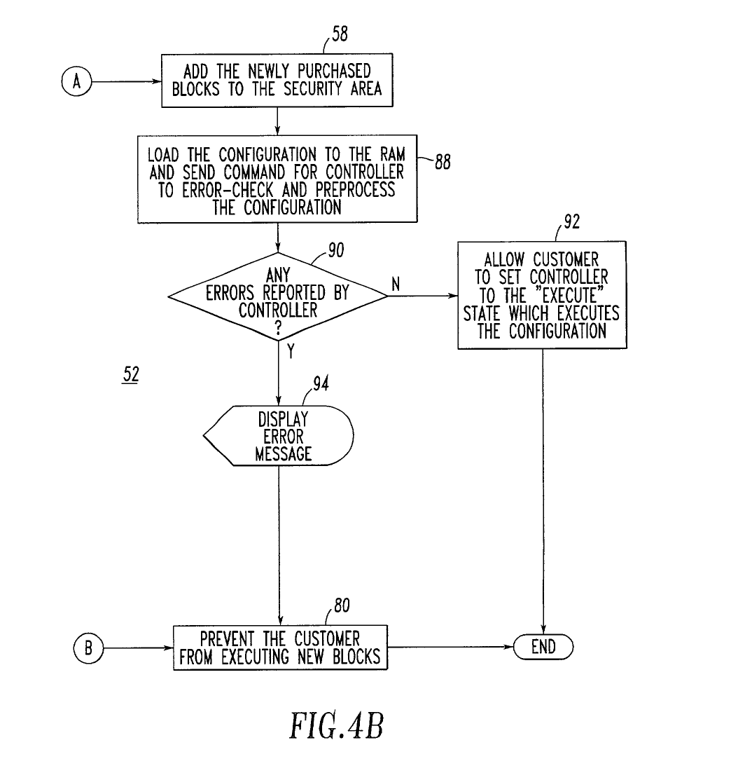

FIGS. 4A and 4B shows an exemplary process 52 for purchasing firmware functional blocks 4 and corresponding purchase codes 68. In the controller 20, each firmware functional block, such as the blocks 42,44 of FIG. 3, requires enabling. Such blocks are enabled by cipher codes based on the unique controller ID 6′ of the controller 20 of FIG. 2. In this manner, each controller 20, as supplied by the supplier 30, has a different cipher code to enable the same block. Hence, a user 28 must purchase separate purchase codes 68 in order to enable the same functional block in different controllers 20.

Referring to FIG. 4A, the customer or user 28 may setup the configuration file 34 of FIG. 2 with one or more unpurchased blocks, but the PROG 22 prevents the user 28 from loading the configuration file 34 until the purchasing blocks process 52 is completed. The purchase codes 68 are based on the unique ID 6′ stored in the controller 20. Hence, every controller 20 has a different purchase code 68 to enable the same functional block 4 (e.g., without limitation, F2, ACVLTADJ 42, AUTO_REG 44). When the supplier 30 supplies the controller 20 with an initial purchased set of the blocks 4, all such blocks are enabled. Preferably, a streamlined process (not shown) is employed by the supplier 30 to enable such blocks.

The user 28 may invoke a purchase blocks command through the PROG 22, in order to purchase additional functional blocks. Otherwise, as discussed below, the process 52 starts automatically if the user 28 attempts to download a file to RAM and the configuration file 34 includes blocks that have not been purchased.

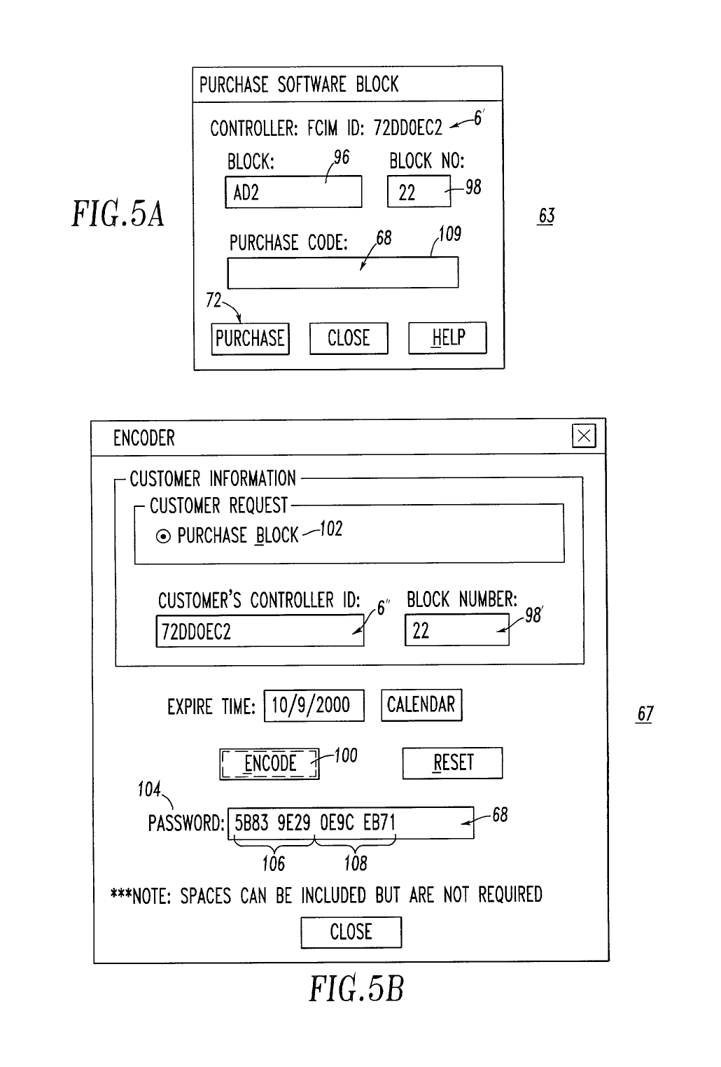

First, at 54, the user 28 opens the configuration file 34 and invokes a download file to RAM command. Then, at 56, the PROG 22 compares the blocks defined in the configuration file 34 with the enabled blocks that have been purchased, in order to determine if there are any (further) unpurchased blocks in the configuration file 34. If not, then execution resumes at 58 of FIG. 4B, where the PROG 22 adds any newly purchased blocks (as purchased below in connection with steps 60,62,64,66,70,74,77,82,84,86) to the controller 20. Otherwise, at 60, the PROG 22 pre-processes a next unpurchased block for purchasing. At 62, the PROG 22 displays a dialog 63 (FIG. 5A) to the user 28, which shows the unique controller ID 6′ and the identifier (e.g., 22) of the current functional block 4 (e.g., AD2). Then, at 64, the user or customer 28 sends or otherwise informs the supplier 30 of the unique controller ID 6′ and the functional block identifier (e.g., 22) for the functional block to be purchased. At 66, the supplier's employee enters the unique controller ID 6′ and the functional block identifier (e.g., 22) into a dialog 67 (FIG. 5B) of the encoder 24 and generates a purchase code 68, which is sent back to the customer 28. For example, the supplier's employee transmits the purchase code 68 to the customer 28 (e.g., via e-mail, telephone, facsimile, letter, any known transmission method and, preferably, a suitably secure transmission method).

Next, at 70, the customer 28 enters the purchase code 68 into the dialog 63 (FIG. 5A) of the PROG 22 clicks Purchase button 72. In turn, the PROG 22 calls the decoder 26, which is effectively the inverse of the encoder 24. At 74, the decoder 26 decodes the purchase code 68 and outputs the decoded data 76. At 77, the PROG 22 determines if the user 28 enters a cancel purchase dialog (not shown), in order to cancel the purchase. If so, then execution resumes at step 80 of FIG. 4B, where the PROG 22 prevents the customer 28 from executing the new blocks. Otherwise, at 82, the PROG 22 determines if the purchase code 68 is valid by examining the data 78, with the decoded identification 78 of the data 76 being equal to the unique ID 6′; and (2) the decoded identifier 79 being equal to the identifier (e.g., 22) of the functional block. If the purchase code 68 was invalid, then, at 84, the PROG 22 displays an error message (not shown) to the user 28 before execution resumes at 62. Otherwise, at 86, the PROG 22 employs the decoded identifier 79 to internally flag the block as having been purchased, and displays a success message (not shown) to the user 28 before execution resumes at 56.

After the PROG 22 determines that there are no further unpurchased blocks in the configuration file 34, at 58 of FIG. 4B, the PROG 22 adds the newly purchased blocks to the controller 20. Any blocks that are not added are, thus, disabled. Then, at 88, the PROG 22 loads the configuration from the configuration file 34 to an application area of the RAM 36 and sends a command for the controller 20 to error-check and pre-process that configuration. If no errors are reported from the controller, at 90, then, at 92, the PROG 22 allows the customer or user 28 to set the controller 20 to the execute state, which executes the new application configuration. Otherwise, if there were any errors, then, at 94, the PROG 22 displays an error message (not shown) to the customer or user 28, and, at 80, prevents the user 28 from executing the new blocks.

FIGS. 5A and 5B are representations of dialog displays 63 and 67 employed by the PROG 22 and the encoder 24, respectively, of FIG. 2. FIG. 5A shows the purchase block dialog 63. The customer 28 initially selects (e.g., from a list of all unpurchased blocks for the controller 20) or enters the block type 96 (e.g., AD2, which in the exemplary embodiment is a conventional analog to digital conversion) and the dialog 63 returns the corresponding block number 98 (e.g., 22). Alternatively, when the process 52 starts automatically, after the user attempts to load a configuration with unpurchased blocks, the block type is automatically selected and is not subject to change.

After the user 28 communicates the unique controller ID 6′ (e.g., 72DD0EC2) and the block number 98 (e.g., 22) to the supplier 30, the supplier's employee enters that information into corresponding entry fields 6″ and 98′ of the encoder dialog 67. The supplier's employee clicks the Encode button 100, and a purchased code 68 (or Password) is generated by the encoder 24 for the functional block to be purchased.

The exemplary encoder 24 employs two 4-byte buffers (‘data1’ and ‘data2’) containing: (1) the unique controller ID 6′ (e.g., 72DD0EC2); and (2)(a) the block number (e.g., 22), and (2)(b) a predefined purchase ID value (e.g., a suitable constant) which is defined by “Purchase Block” selection 102. Hence, the HIWORD(data2)=block number (e.g., 22), and the LOWORD(data2)=the identifier for block purchase (e.g., the predefined constant). The encoder 24 employs a suitable private key (e.g., any suitable constant; a constant value in the code for both the decoder 26 and the encoder 24; an identical value, which is accessible by both the decoder 26 and the encoder 24). The exemplary private key has a suitable length such as, for example, four 32-bit numbers, or one 32-bit number. The returned purchase code 68 is displayed in the dialog 67 in the Password (Purchase Code) field 104. In this example, the encoded outputs of the encoder 24 include a ‘code1’ 106 (e.g., 5B839E29 in this example), which is the first/most significant double word of the purchase code 68; and a ‘code2’ 108 (e.g., 0E9CEB71 in this example), which is the second/least significant double word of the purchase code 68. The exemplary encoder 24 employs a suitable encryption algorithm (e.g., without limitation, a cryptographic algorithm or cipher, a block cipher, an iterated block cipher, a Feistel cipher, a Feistel-like cipher, IDEA, a DES-cipher, a DES-like cipher, SAFER) having the secret or private key.

In turn, the supplier 30 communicates the purchase code 68 to the user 28. The user enters the purchase code 68 into the purchase code box 109 of the dialog 63, and clicks the Purchase button 72, which calls the decoder 26.

The decoder 26 employs a corresponding decryption algorithm (i.e., with respect to the encoder 24 having the same secret key). The decoder 26 inputs the purchase code 68 into the decryption algorithm and outputs a decrypted controller number (e.g., the identification 14 of FIG. 1) and a decrypted block number (e.g., the identifier 16 of FIG. 1) from the decryption algorithm. The purchase code 68 is input as the argument ‘code’ including: (1) ‘code1’ (e.g., 5B839E29 in this example), which is the first/most significant double word of the purchase code 68; and (2) ‘code2’ (e.g., 0E9CEB71 in this example), which is the second/least significant double word of the purchase code 68. In turn, the decoder 26 outputs the argument ‘data’ including: (1) ‘data1’ containing the unique controller ID 6′ (e.g., 72DD0EC2); (2)(a) HIWORD(data2)=block number (e.g., 22), and (2)(b) LOWORD(data2)=the identifier for block purchase (e.g., the predefined constant). Therefore, as shown by this example, for valid encoding and decoding, the output of the decoder 26 is identical to the input of the encoder 24. Although exemplary data structures have been disclosed for the inputs and outputs of the encoder 24 and decoder 26, any suitable structures may be employed for the purpose of encoding and decoding the unique controller ID and the block number.

The customer 28 repeats the above steps for each block purchase.

The present invention requires no customizing of firmware or software of the exemplary controller 20, and does not send a common software or hardware key to a customer in order to enable software and/or hardware functions. Instead, purchase codes are based upon the unique controller IDs 6,6′ and the identifier of the functional block of interest. This allows a complete standard set of configuration software and control firmware to be supplied in corresponding controller products.

While for clarity of disclosure reference has been made herein to dialog displays 63,67 of the PCs 32,40 for displaying dialogs and decoder and encoder information, it will be appreciated that such dialogs and information may be stored, printed on hard copy, be computer modified, or be combined with other data. All such processing shall be deemed to fall within the terms “display” or “displaying” as employed herein.

While specific embodiments of the invention have been described in detail, it will be appreciated by those skilled in the art, that various modifications and alternatives to those details could be developed in light of the overall teachings of the disclosure. Accordingly, the particular arrangements disclosed are meant to be illustrative only, and not limiting as to the scope of invention which is to be given the full breadth of the claims appended and any and all equivalents thereof.

What is claimed is:

1. A method of enabling at least one functional block having an identifier for a controller having a unique identification, said method comprising the steps of:
encoding an enable code for the functional block of said controller based upon the unique identification of said controller and the identifier of said functional block;
decoding the enable code for the functional block of said controller to obtain a decoded identification and a decoded identifier; and
enabling the functional block of said controller when said decoded identification is equal to said unique identification and said decoded identifier is equal to the identifier of said functional block.

2. The method of claim 1 further comprising:
selling the enable code for the functional block of said controller based upon the unique identification of said controller and the identifier of said functional block.

3. The method of claim 1 further comprising:
purchasing the enable code for the functional block of said controller based upon the unique identification of said controller and the identifier of said functional block.

4. The method of claim 1 further comprising:
employing a plurality of said functional blocks;
enabling at least one of said functional blocks in said controller; and
disabling at least one of said functional blocks in said controller.

5. The method of claim 1 further comprising:
entering the identifier of said functional block and the unique identification of said controller into an encoder;
encoding a purchase code as said enable code from the identifier of said functional block and the unique identification of said controller; and
selling said purchase code.

6. The method of claim 5 further comprising:
sending the purchase code to a customer.

7. The method of claim 6 further comprising:
employing one of a telephone, a facsimile, an electronic mail message, and a letter to send the purchase code to the customer.

8. The method of claim 6 further comprising:
storing the purchase code on a memory device; and
sending the memory device to the customer.

9. The method of claim 8 further comprising:
employing a disk as said memory device.

10. The method of claim 1 further comprising:
displaying an error message when said decoded identification is not equal to said unique identification.

11. The method of claim 1 further comprising:
displaying an error message when said decoded identifier is not equal to the identifier of said functional block.

12. The method of claim 1 further comprising:
employing said encoding step remotely from said decoding step.

13. The method of claim 1 further comprising:
employing at least one of said encoding step and said decoding step on a personal computer.

14. The method of claim 1 further comprising:
employing an encryption algorithm having a secret key as said encoding step; and
employing a corresponding decryption algorithm having said secret key as said decoding step.

15. The method of claim 14 further comprising:
employing a block number as the identifier of said functional block;
employing a unique controller number as the unique identification of said controller;
inputting the block number and the unique controller number into said encryption algorithm;
outputting a purchase code as said enable code from said encryption algorithm;
inputting said purchase code into said decryption algorithm;
outputting a decrypted block number and a decrypted controller number from said decryption algorithm; and
enabling the functional block of said controller when said decrypted block number is equal to said identifier of said functional block and said decrypted controller number is equal to said unique identification.

16. The method of claim 5 further comprising:
employing an application area in said controller;
loading an application including said at least one of said functional blocks to said application area; and
executing said application in said controller.

17. The method of claim 16 further comprising:
employing a configuration file including at least some of said functional blocks;
checking said configuration file for unpurchased functional blocks; and
purchasing one of said unpurchased functional blocks.

18. The method of claim 17 further comprising:
checking said configuration file for another one of said unpurchased functional blocks; and
purchasing said another one of said unpurchased functional blocks.

19. The method of claim 15 further comprising:
displaying the unique controller number and the block number;
informing a supplier of said unique controller number and said block number; and
inputting said unique controller number and said block number into said encryption algorithm at a facility of said supplier.
